(19) United States
(12) Patent Application Publication
(10) Pub. No.: US 2005/0211053 A1
(43) Pub. Date: Sep. 29, 2005

(54) Stringed instrument pick

(76) Inventor: Malcolm Ball, Alpharetta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/799,079

(22) Filed: Mar. 12, 2004

(51) Int. Cl. G10D 3/16

(52) U.S. Cl. 84/322

(57) ABSTRACT

A stringed instrument pick comprising a curved and broadened peripheral lip adapted to effectively engage a user's thumb, wherein the pick incorporates a plurality of raised grip pads structurally adapted to interface with the grooves of the user's thumb prints and index finger prints, thus significantly reducing, or eliminating, slipping of the pick from the user's gripping fingers, and/or undesirable rotational, lateral and/or radial movement of same therebetween, during play of the guitar.

### CROSS-REFERENCE AND PRIORITY CLAIM TO RELATED APPLICATIONS

To the fullest extent permitted by law, the present nonprovisional patent application claims priority to and the full benefit of design patent application entitled “STRINGED INSTRUMENT PICK”, filed on Feb. 17, 2004, having assigned Ser. No. 29/199,701.

### TECHNICAL FIELD

The present invention relates generally to musical instrument accessories, and more specifically to a stringed instrument pick, wherein the present invention is particularly advantageous for its ability to significantly reduce, or eliminate, undesirable rotational, lateral and/or radial movement or slippage of the pick as held between the user's thumb pad and index finger during play of the stringed instrument; and thus, enable the user to maintain the picking surface of the pick in the proper, or selected, position or orientation while strumming the strings of the instrument.

### BACKGROUND OF THE INVENTION

Guitars are amongst the variety of stringed instruments popularly played by amateurs and professional musicians alike. Like most stringed instruments, guitars are typically played by positioning the body of the guitar on the lap or near the waist of the user. The user then grasps the neck or fret board of the guitar with his/her “fretting hand”, and positions his/her “picking hand” proximal to the bridge of the guitar. Thereafter, the user may freely strum or pick the various strings of the guitar with a guitar pick—typically held between the user's thumb pad and index finger of the picking hand.

Although initially learning to properly hold the guitar and guitar pick in a generally stationary or passive manner requires minimal effort, learning to properly balance the guitar and maintain the pick in a selected orientation during active play of the guitar presents significant challenges or hurdles that may be overcome only upon staunch discipline, patience, and dedication to a regular practice regimen. Specifically, although developing the requisite finger strength and dexterity of the fretting hand poses notable challenges, holding the pick in the proper position or angle relative to the bridge and strings of the guitar, implementing the proper strumming pattern and force at which the pick is brought over the strings, and holding the pick with the precise finger pressure, can present an equally exigent task.

Unfortunately, many currently available guitar picks do not provide the user with an effective means to grasp and maintain the pick between the user's thumb pad and index finger of the picking hand. As such, during heavy play and/or continuous strumming of the guitar strings, the pick tends to slip from the user's gripping fingers, rotate between the user's gripping fingers, and/or move therebetween in a radial and/or lateral direction relative to the guitar strings. Indeed, disruption of proper or selected pick orientation can have significant ramifications on a user's guitar play, including frustration toward the learning process, and thus, potential cessation of guitar play and practice altogether.

Furthermore, although some available guitar picks comprise appendages adapted to wrap around or fully encircle the user's thumb, such picks do not possess a rear peripheral base or lip broad enough to effectively cup the inner side of the user's thumb, and, as such, do not provide the support ostensibly offered by the structural nature thereof. Examples of such devices may be seen with reference to U.S. Pat. No. 6,346,662 to Sielaff, and U.S. Pat. No. 5,509,341 to Dunlop.

Moreover, conventional grip textures integrally formed on the face of most guitar picks typically fail to provide the necessary interface for maintaining a stationary position between the user's gripping fingers, and thus are vulnerable to undesirable rotational, lateral and/or radial movement therebetween and/or slippage therefrom during play of the guitar. Examples of such devices may be seen with reference to U.S. Pat. No. 5,648,622 to Storey.

Therefore, it is readily apparent that there is a need for a stringed instrument pick adapted to be grasped and securely maintained between the user's thumb pad and index finger in a desired position or orientation relative to the strings of the guitar, wherein the advantageous structural design of the pick substantially reduces, or eliminates, slippage of the pick from the user's gripping fingers, and/or undesirable rotational, lateral and/or radial movement of same therebetween, during play of the guitar.

### BRIEF SUMMARY OF THE INVENTION

Briefly described, in a preferred embodiment, the present invention overcomes the above-mentioned disadvantages and meets the recognized need for such a device by providing a stringed instrument pick comprising a curved and broadened peripheral lip adapted to effectively engage a user's thumb, wherein the pick incorporates a plurality of raised grip pads structurally adapted to interface with the grooves of the user's thumb prints and index finger prints, thus significantly reducing, or eliminating, slippage of the pick from the user's gripping fingers, and/or undesirable rotational, lateral and/or radial movement of same therebetween, during play of the guitar.

According to its major aspects and broadly stated, the present invention in its preferred form is a stringed instrument pick having, in general, a curved and broadened peripheral lip and a plurality of raised grip pads or protuberances.

More specifically, the present invention is a stringed instrument pick, wherein the pick comprises a curved and broadened peripheral lip adapted to engage and grip the inner side and/or pad of the user's thumb during play of the guitar (or other stringed instrument). Additionally, preferably formed on the first face and second face of the pick are a plurality of approximately elongated, preferably rectangularly-shaped raised grip pads, wherein each grip pad comprises sharply right-angled edges. Preferably, the right-angled edges of each raised pad disposed on the first face of the pick are adapted to interface with the grooves of the user's thumb prints. Similarly, the right-angled edges of each raised pad disposed on the second face of the pick are adapted to interface with the fingerprint grooves of the user's index finger. As such, the curved and broadened peripheral lip of the pick, in conjunction with the plurality of raised grip pads adapted to interface with the user's fingerprint grooves, preferably collectively function to assist in maintaining the pick within the user's gripping fingers in a selected orientation by substantially reducing, or eliminating, slippage of the pick from the user's grip, and/or undesirable rotational, lateral and/or radial movement of same therebetween, during play of the guitar.

Accordingly, a feature and advantage of the present invention is its ability to be grasped and securely maintained between the user's thumb pad and index finger in a desired position or orientation relative to the strings of the guitar (or other stringed instrument).

Another feature and advantage of the present invention is its curved and broadened peripheral lip and generally advantageous structural design that substantially reduces, or eliminates, slipping of the pick from the user's gripping fingers, and/or undesirable rotational, lateral and/or radial movement of same therebetween, during play of the guitar; thus, extending practical uninterrupted play time.

Still another feature and advantage of the present invention is its provision of a plurality of raised and sharply right-angled grip pads adapted to interface with the user's fingerprint grooves, thereby maintaining the pick within the user's grip in a selected orientation relative to the strings of the guitar.

Still yet another feature and advantage of the present invention is its ability to be utilized for playing a variety of stringed instruments, including, but not limited to, electric guitars, acoustic guitars, bass guitars, long neck banjos, tenor banjos, ukuleles, and the like.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a stringed instrument pick according to a preferred embodiment of the present invention;

FIG. 2 is a perspective view of a stringed instrument pick according to a preferred embodiment of the present invention;

FIG. 3 is a perspective view of a stringed instrument pick according to a preferred embodiment of the present invention;

FIG. 4 is a perspective view of a stringed instrument pick according to a preferred embodiment of the present invention;

FIG. 5 is a side view of a stringed instrument pick according to a preferred embodiment of the present invention;

FIG. 6 is a side view of a stringed instrument pick according to a preferred embodiment of the present invention;

FIG. 7 is a top view of a stringed instrument pick according to a preferred embodiment of the present invention;

FIG. 8 is a bottom view of a stringed instrument pick according to a preferred embodiment of the present invention;

FIG. 9 is a perspective view of a stringed instrument pick according to a preferred embodiment of the present invention, shown in use;

FIG. 10 is a perspective view of a stringed instrument pick according to a preferred embodiment of the present invention, shown in use;

FIG. 11 is a perspective view of a stringed instrument pick according to a preferred embodiment of the present invention, shown in use;

FIG. 12 is a perspective view of a stringed instrument pick according to an alternate embodiment of the present invention;

FIG. 13 is a perspective view of a stringed instrument pick according to an alternate embodiment of the present invention;

FIG. 14 is a perspective view of a stringed instrument pick according to an alternate embodiment of the present invention;

FIG. 15 is a perspective view of a stringed instrument pick according to an alternate embodiment of the present invention;

FIG. 16 is a perspective view of a stringed instrument pick according to an alternate embodiment of the present invention;

FIG. 17 is a top view of a stringed instrument pick according to an alternate embodiment of the present invention; and,

FIG. 18 is a top view of a stringed instrument pick according to an alternate embodiment of the present invention.

### DETAILED DESCRIPTION OF THE PREFERRED AND SELECTED ALTERNATIVE EMBODIMENTS

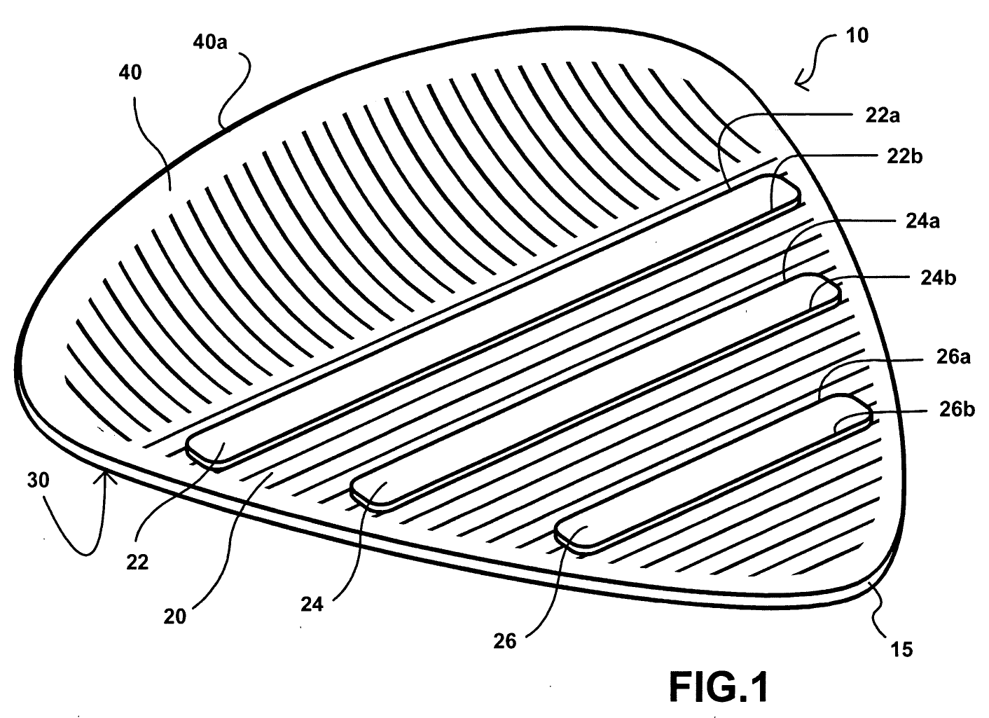

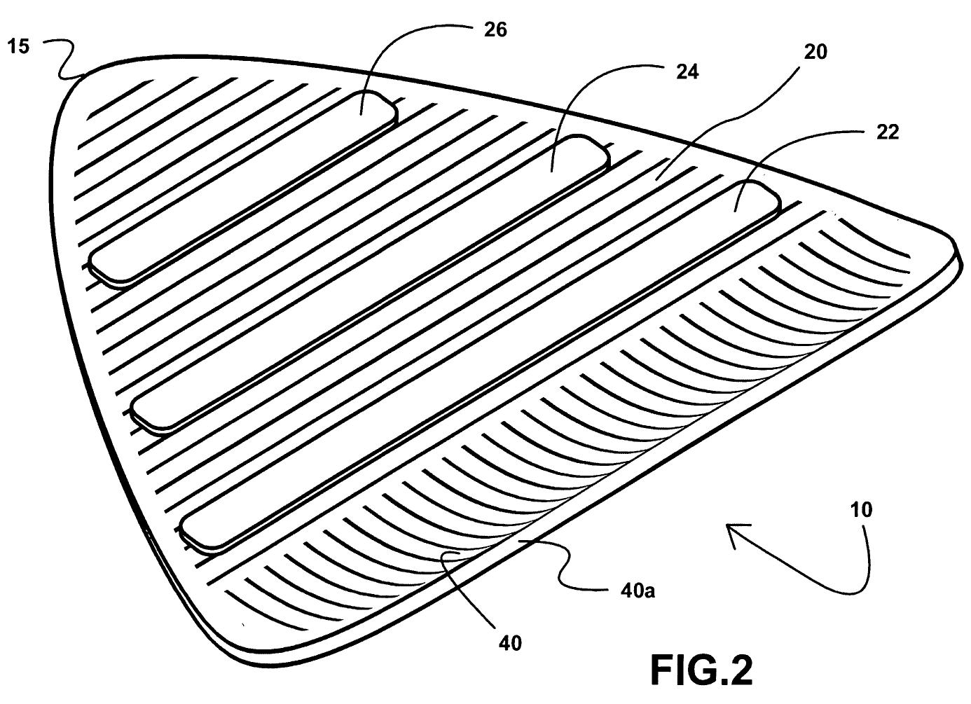

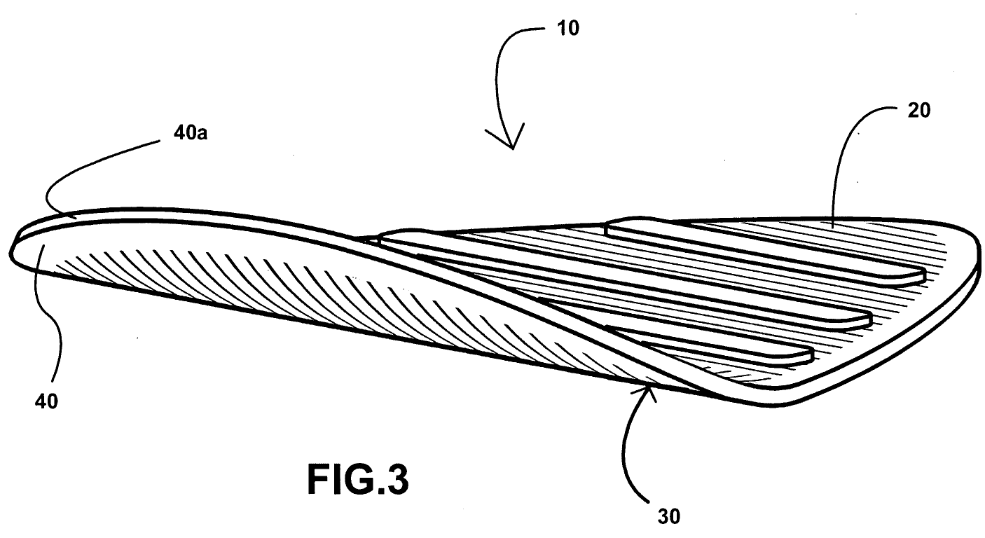

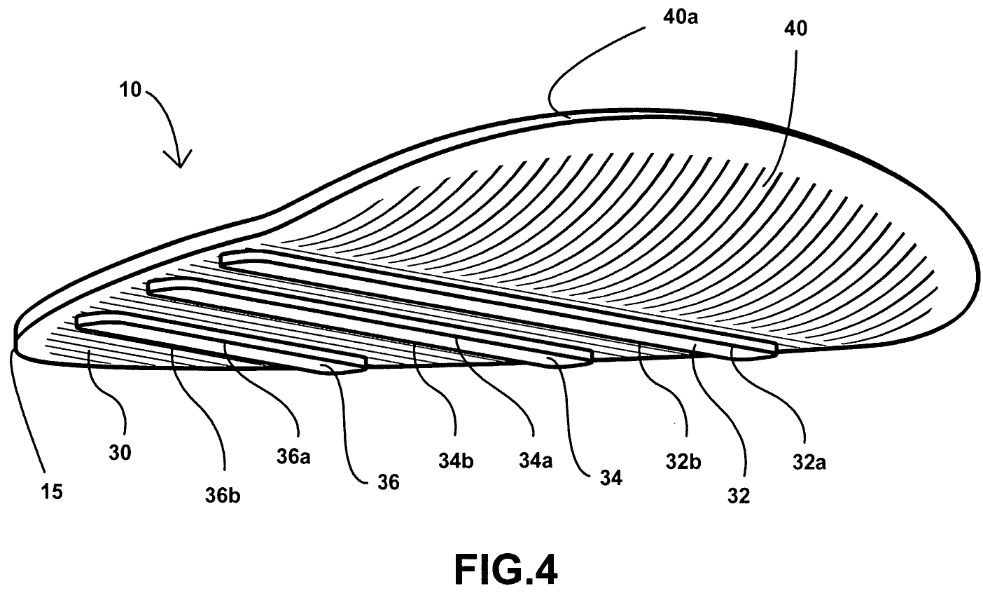

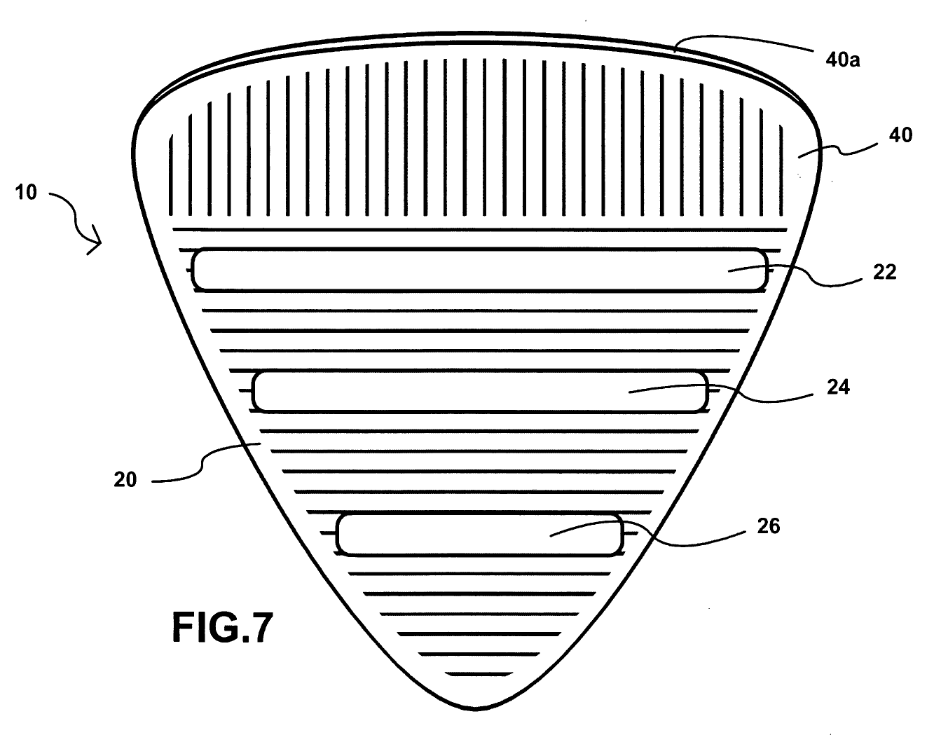

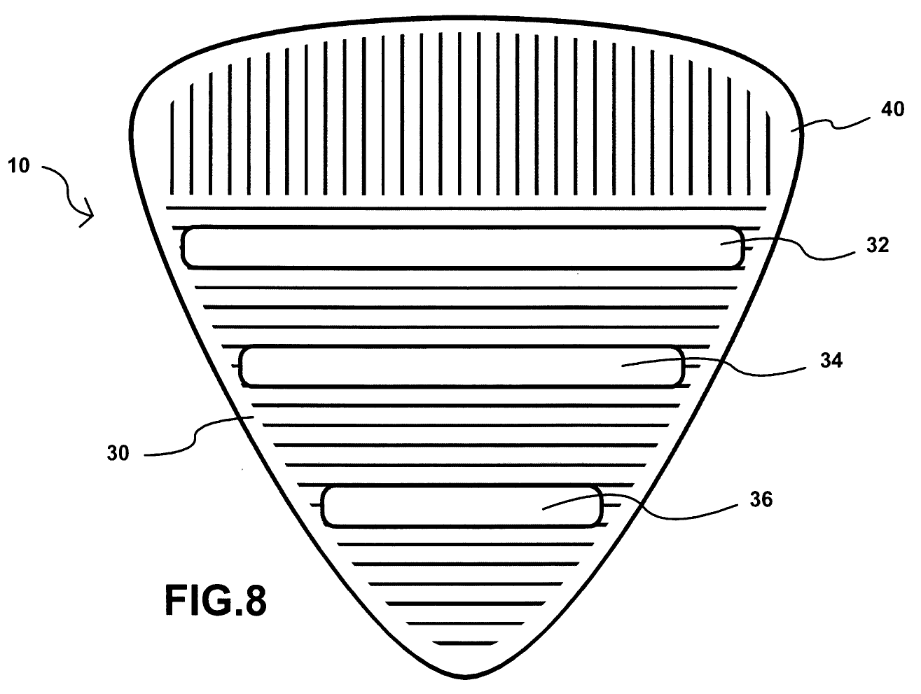

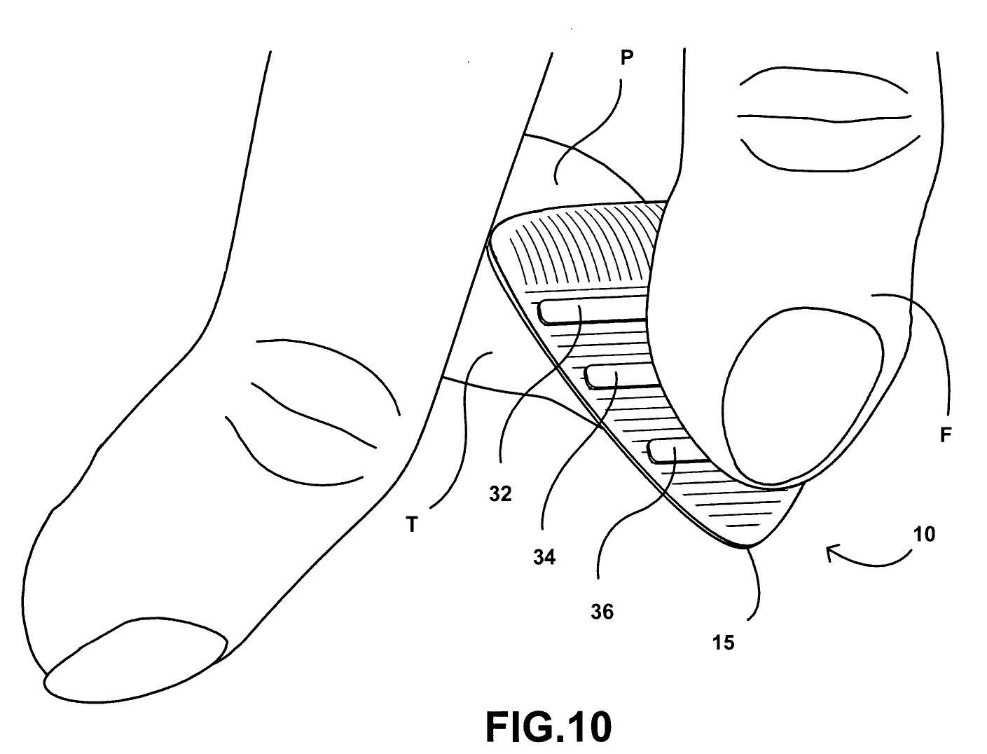

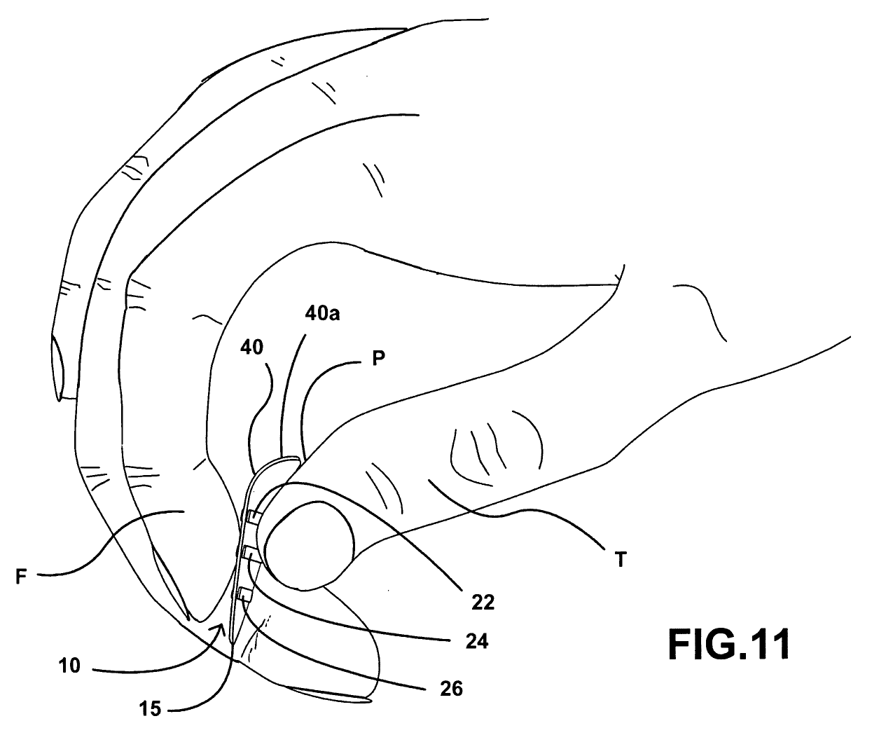

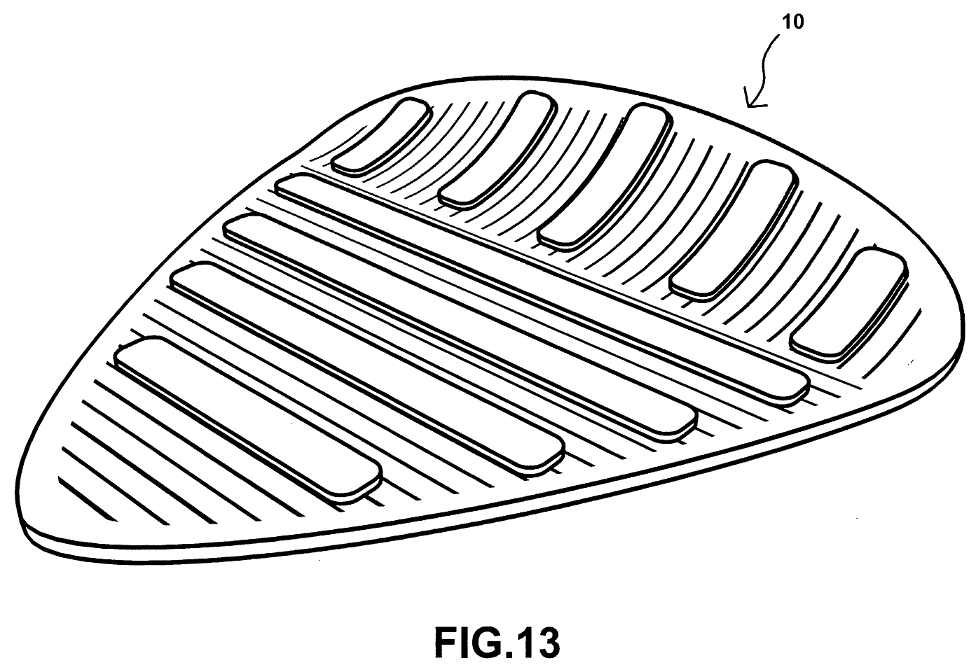

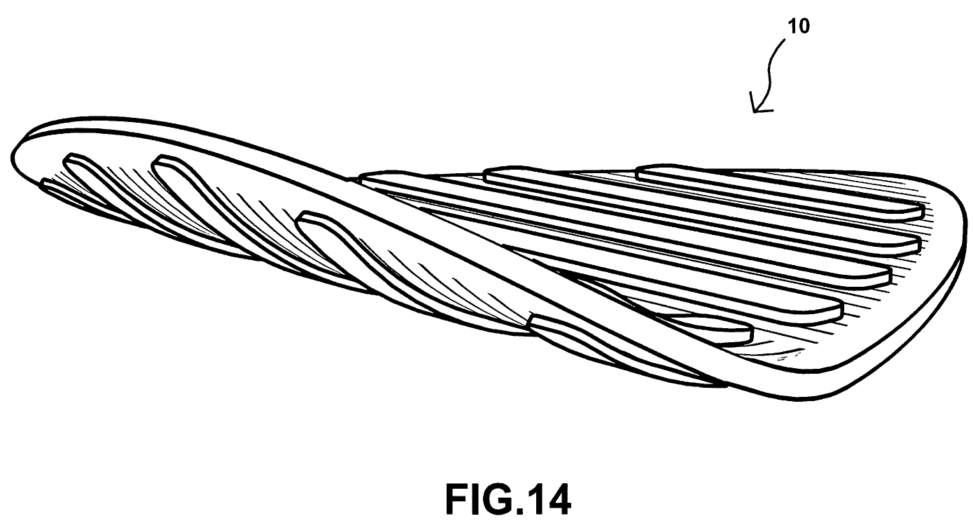

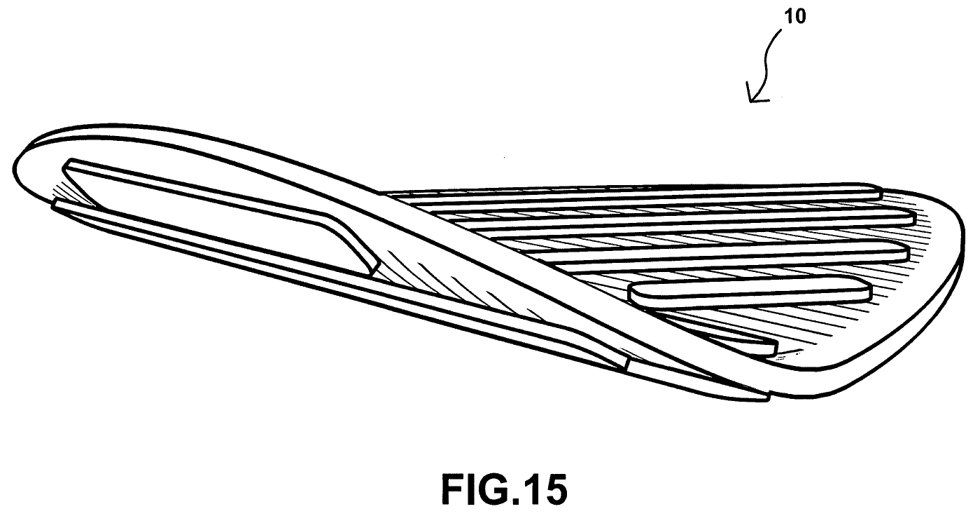

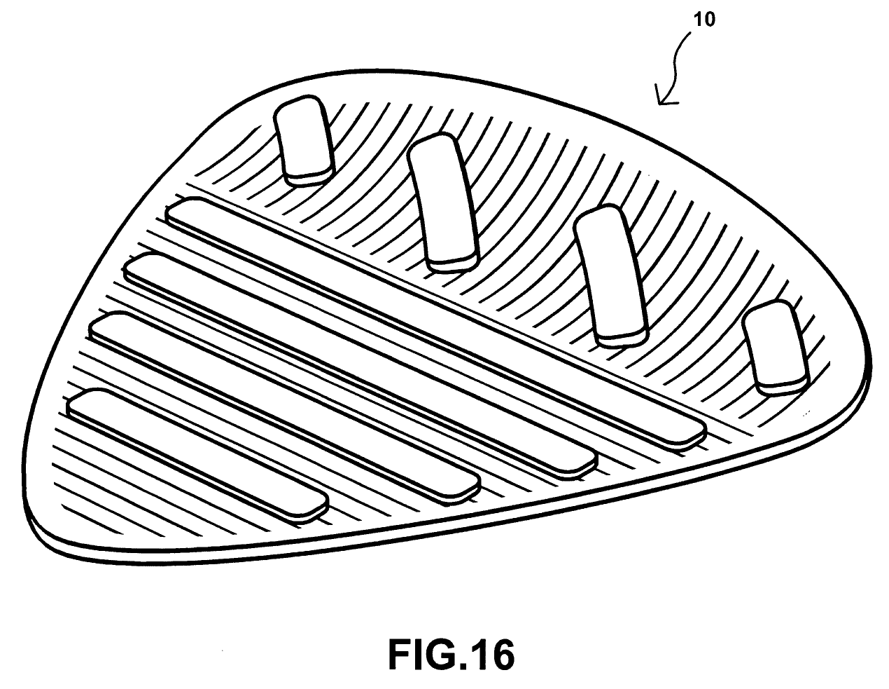

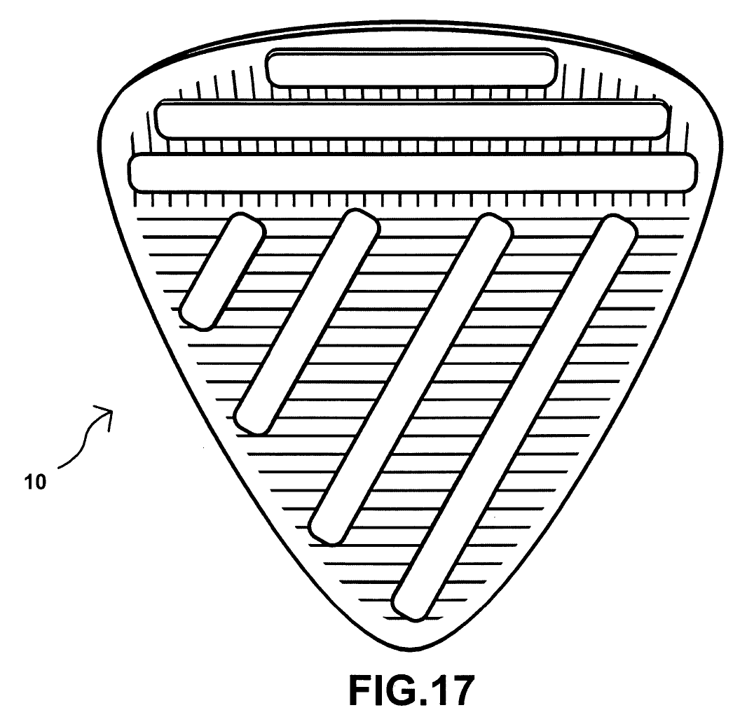

In describing the preferred and selected alternate embodiments of the present invention, as illustrated in FIGS. 1-18, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-8, the present invention in a preferred embodiment is an approximately L-shaped stringed instrument pick 10 comprising first face 20, second face 30, and curved and broadened peripheral base or lip 40. Pick 10 is preferably generally manufactured from a suitable plastic, and may further be manufactured to any selected dimension and/or pick thickness. Alternatively, pick 10 may be manufactured from other suitable materials, such as wood or metal. Additionally, picking tip 15 of pick 10 is preferably rounded; however, it is contemplated that picking tip 15 could be pointed, as is known within the art, or, alternatively, could be manufactured to comprise any selected shape or contour. It should be recognized that pick 10 could comprise a variable thickness, wherein picking tip 15 could be manufactured with a thickness less than the thickness of opposing peripheral lip 40, or similar variations or permutations thereof.

Preferably, peripheral lip 40 of pick 10 is preferably substantially broadened and sloped or curved to facilitate effective engagement of same to the user's thumb pad P and/or inner side IS of the user's thumb P. That is, the broad and sloped or curved structural nature of peripheral lip 40 is preferably adapted to receive and securely grip the natural curvature of the user's thumb pad P and/or inner side IS of the user's thumb T, and thus permit the contacting portion of the user's thumb T to conform therewith. Additionally, pick 10 may be securely held between the user's gripping fingers such that edge 40a of peripheral lip 40 is forcibly pressed into the user's thumb pad P via the user's index finger F, and thus, maintained in a selected position via thumb pad P frictionally overlapping edge 40a of peripheral lip 40. Accordingly, and as more fully described below, curved peripheral lip 40 assists in maintaining pick 10 within the user's grip in a selected orientation, thereby substantially reducing, or eliminating, slipping of pick 10 from the user's gripping fingers, and/or undesirable rotational, lateral and/or radial movement of same therebetween, during play of a selected stringed instrument.

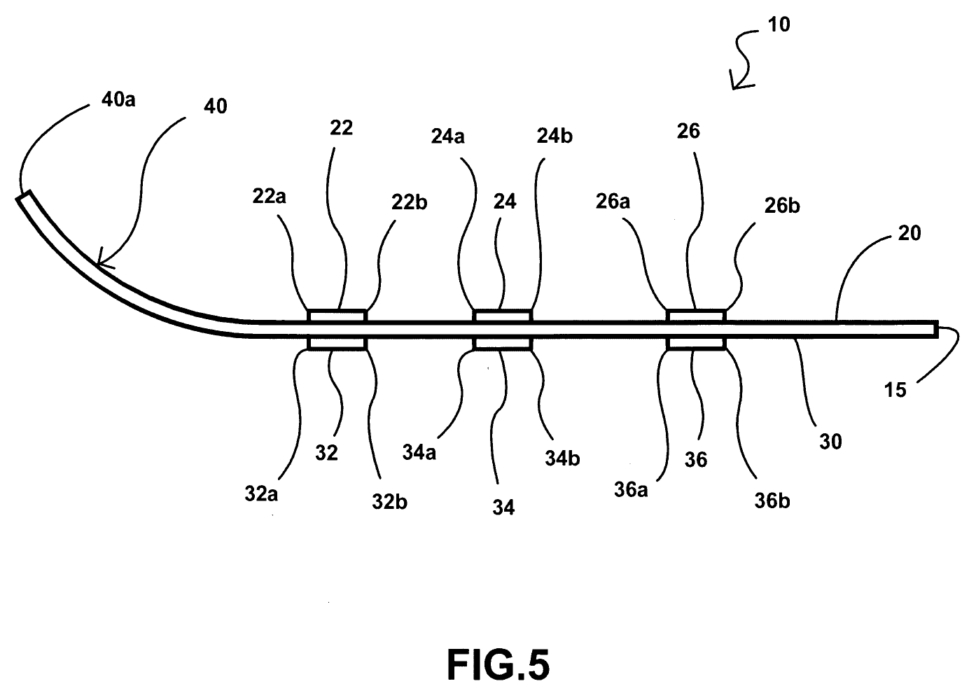

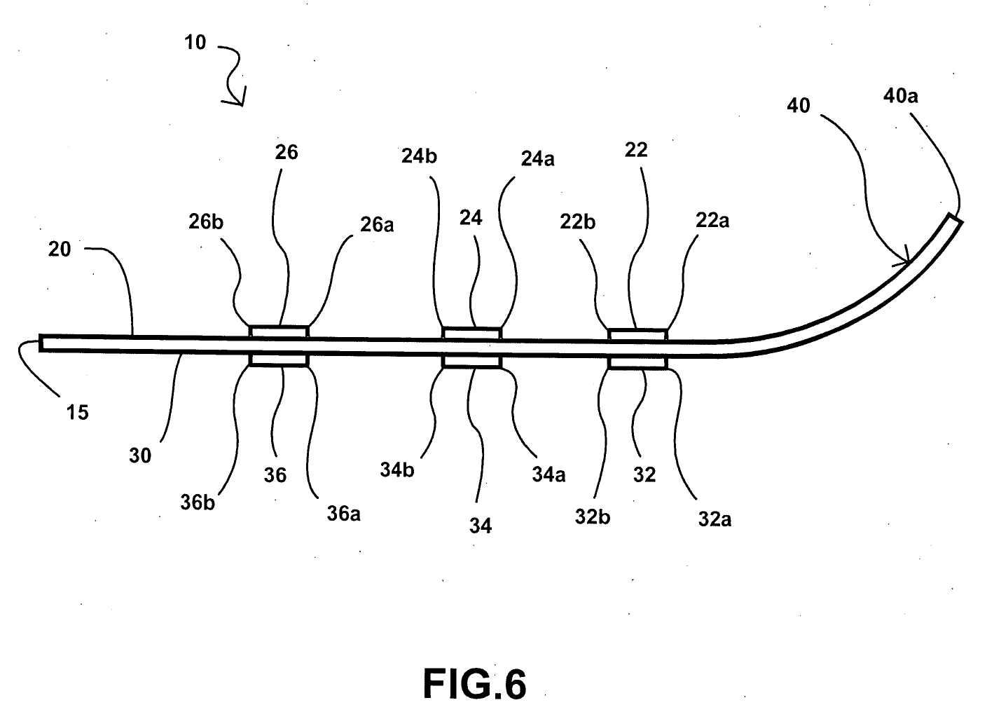

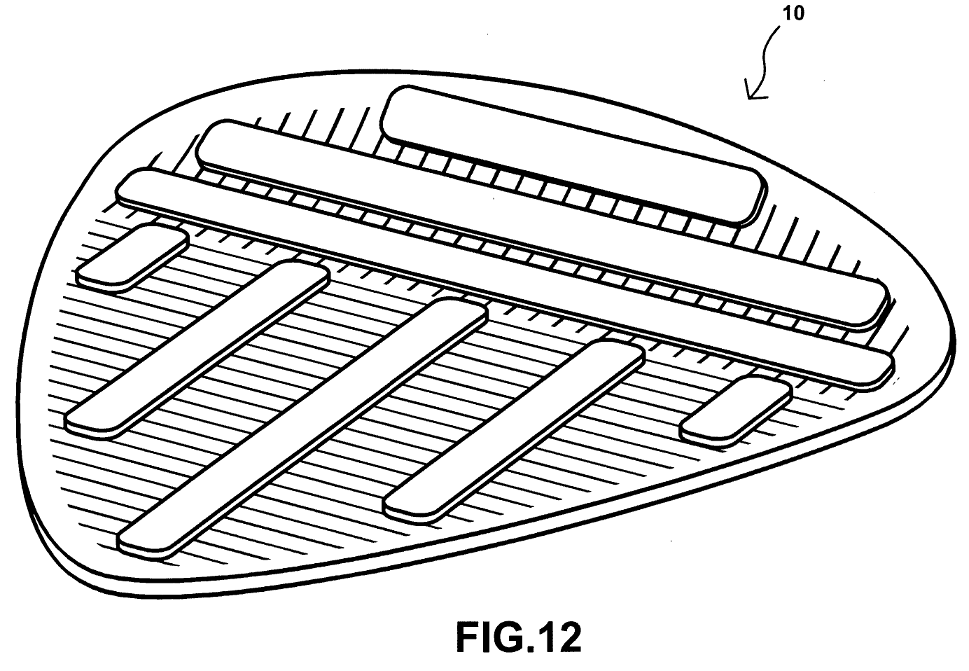

Preferably disposed upon, and integrally formed with, first face 20 of pick 10 are approximately elongated rectangularly-shaped raised grip pads 22, 24, 26, preferably equally-spaced and aligned parallel one with respect to each other. Similarly, preferably disposed upon, and integrally formed with, second face 30 of pick 10 are approximately elongated rectangularly-shaped raised grip pads 32, 34, 36, preferably equally-spaced and aligned parallel one with respect to each other. As best illustrated in FIGS. 5-6, grip pads 22, 24, 26 of first face 20 are preferably aligned over grip pads 32, 34, 36, respectively, of second face 30, wherein such a configuration preferably facilitates grasping of pick 10, and generally enhances the user's tactile response over same during play of the stringed instrument; thereby, enabling effective orientation of pick 10 between the user's gripping fingers. It should be recognized, however, that grips pads 22, 24, 26 of first face 20, and grip pads 32, 34, 36 of second face 30, could be disposed over pick 10 in any selected arrangement and/or configuration, such as, for exemplary purposes only, a fully staggered configuration, a partially staggered configuration, an unequally-spaced configuration, a fully angled configuration, a partially angled configuration, a fully random configuration, a partially random configuration, and/or combinations thereof, wherein any such configuration may be selectively formed on first face 20 and/or second face 30, as best illustrated in FIGS. 12-17. It should further be recognized that pick 10 could be manufactured with grip pads formed only on first face 20 or second face 30, or alternatively, with any selected number of grip pads.

Preferably, grip pads 22, 24, 26 of first face 20 comprise sharply right-angled edges 22a and 22b, 24a and 24b, and 26a and 26b, respectively, wherein grip pads 32, 34, 36 of second face 30 similarly preferably comprise sharply right-angled edges 32a and 32b, 34a and 34b, and 36a and 36b, respectively. Preferably, sharply right-angled edges 22a, 22b, 24a, 24b, 26a, 26b, of respective grip pads 22, 24, 26, are adapted to be received within or interfaced with the grooves of the user's thumb prints of thumb T. Similarly, sharply right-angled edges 32a, 32b, 34a, 34b, 36a, 36b, of respective grip pads 32, 34, 36, are adapted to be received within or interfaced with the fingerprint grooves of the user's index finger F, preferably positioned on second face 30 of pick 10 during play of the stringed instrument. As such, curved and broadened peripheral lip 40 of pick 10, in conjunction with raised grip pads 22, 24, 26, 32, 34, 36 adapted to interface with the user's fingerprint grooves, preferably collectively function to assist in maintaining pick 10 within the user's gripping fingers in a selected orientation; thereby, substantially reducing, or eliminating, slipping of pick 10 from the user's gripping fingers, and/or undesirable rotational, lateral and/or radial movement of same therebetween, during play of the stringed instrument, as more fully described below. Although the present invention contemplates that pick 10 rest between the user's fingers such that first face 20 of pick 10 contacts the user's thumb T, and that second face 30 of pick 10 contacts the user's index finger F, it should be recognized that pick 10 may be oriented and held between the user's finger grips in any selected position, and/or between any selected fingers and/or selected finger-and-thumb combination.

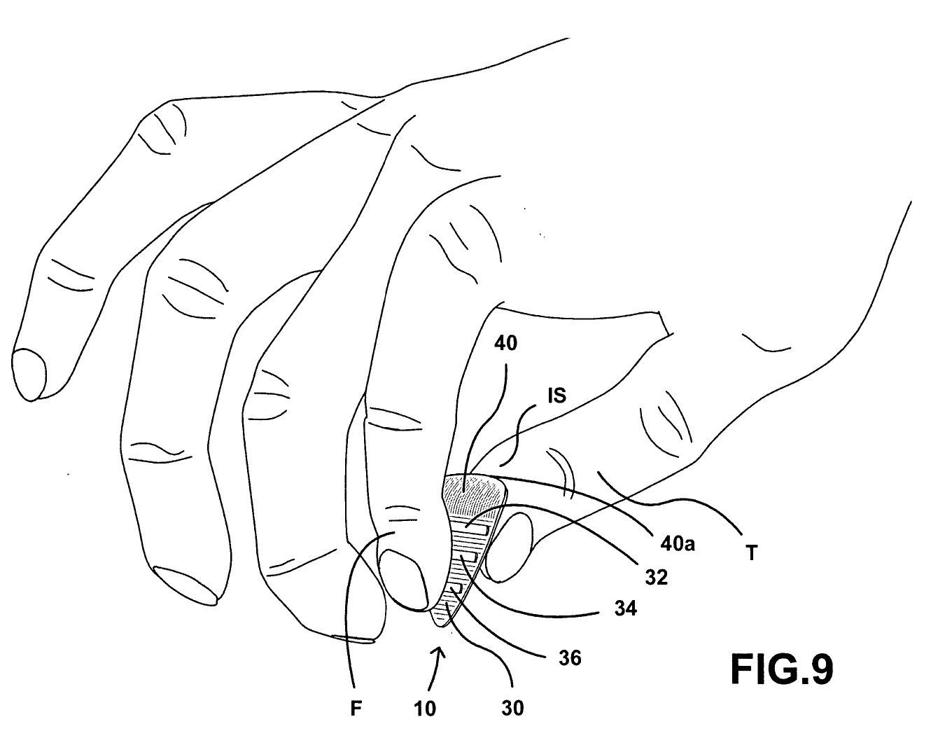

Referring now to FIGS. 9-11, in use, pick 10 is preferably held between the user's thumb T and index finger F, wherein thumb pad P and/or inner side IS of the user's thumb T preferably contacts first face 20 of pick 10, and wherein index finger F preferably contacts second face 30 of pick 10. Additionally, and as described above, the grooves of the user's thumb prints and index finger fingerprints preferably interface with sharply right-angled edges 22a, 22b, 24a, 24b, 26a, 26b, 32a, 32b, 34a, 34b, 36a, 36b of respective grip pads 22, 24, 26, 32, 34, 36 formed on respective first face 20 and second face 30. Thereafter, the user is preferably free to strum or pick the strings of the stringed instrument with pick 10, wherein the collective and interactive frictional forces imparted and/or created between the user's thumb T and index finger F over grip pads 22, 24, 26, 32, 34 and 36 of respective first face 20 and second face 30, cooperatively associate with curved peripheral wall 40 to preferably substantially reduce, or eliminate, slippage of pick 10 from the user's gripping fingers, and/or undesirable rotational, lateral and/or radial movement of same therebetween, during play of the stringed instrument.

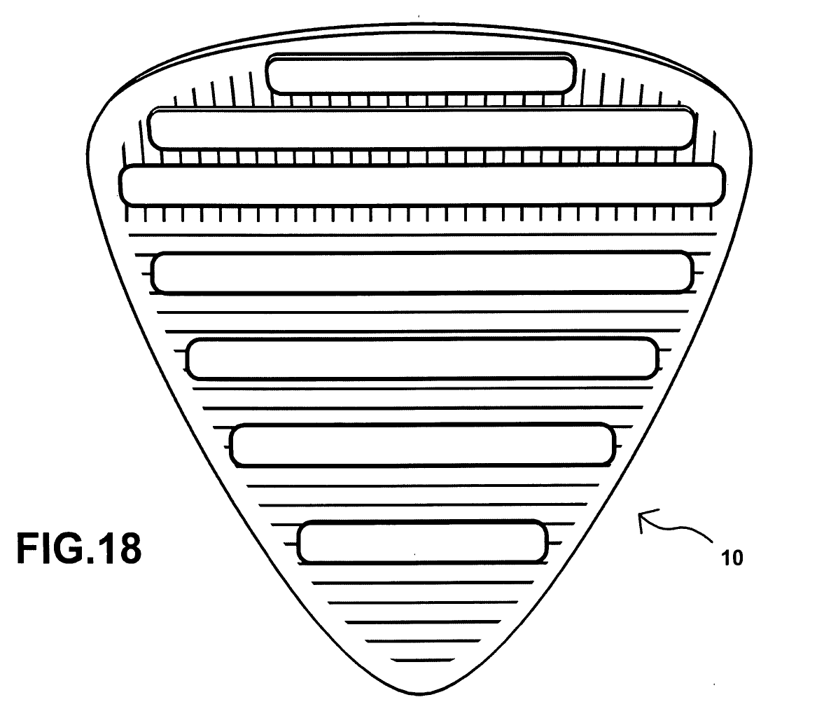

As best illustrated in FIG. 18, it is contemplated in an alternate embodiment that curved peripheral wall 40 could also incorporate raised grip pads over at least a portion thereof.

It is contemplated in another alternate embodiment that pick 10 may incorporate grip pads of other shapes comprising sharply right-angled edges, such as, for exemplary purposes only squares, diamonds, circles, ovals, conical-shaped pads, frustoconical-shaped pads, trapezoidal-shaped pads, rhomboidal-shaped pads, crosses, X-shaped pads, Y-shaped pads, Z-shaped pads, and/or the like.

It is contemplated in still another alternate embodiment that pick 10 may incorporate elastomeric grip pads and/or grip pads having an abrasive or high-friction surface.

It is contemplated in yet another alternate embodiment that pick 10 could incorporate a plurality of raised pads in the form of wedge-shaped ridges or ridges comprising triangular cross-section, wherein the apex of each such ridge could effectively interface with the user's fingerprint grooves.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A stringed instrument pick, comprising:
an approximately L-shaped configuration defined by a first face, a second face, and a curved peripheral lip.

2. The stringed instrument pick of claim 1, wherein said first face comprises at least one raised grip pad formed over at least a portion thereof.

3. The stringed instrument pick of claim 2, wherein said at least one raised grip pad comprises at least one edge adapted to be received by and interface with a groove of a fingerprint or a thumb print.

4. The stringed instrument pick of claim 2, wherein said at least one raised grip pad comprises at least one sharply angled edge, said at least one sharply angled edge adapted to be received by and interface with a groove of a fingerprint or a thumb print.

5. The stringed instrument pick of claim 2, wherein said curved peripheral lip is adapted to engage the natural curvature of a user's finger or thumb surface.

6. The stringed instrument pick of claim 1, wherein said second face comprises at least one raised grip pad formed over at least a portion thereof.

7. The stringed instrument pick of claim 6, wherein said at least one raised grip pad comprises at least one edge adapted to be received by and interface with a groove of a fingerprint or a thumb print.

8. The stringed instrument pick of claim 6, wherein said at least one raised grip pad comprises at least one sharply angled edge, said at least one sharply angled edge adapted to be received by and interface with a groove of a fingerprint or a thumb print.

9. The stringed instrument pick of claim 6, wherein said curved peripheral lip is adapted to engage the natural curvature of a user's finger or thumb surface.

10. A stringed instrument pick, comprising:
a first face and a second face, wherein at least one of said first face and said second face comprises at least one raised grip pad formed over at least a portion thereof, said at least one raised grip pad adapted to be received by and interface with a user's fingerprint groove.

11. The stringed instrument pick of claim 10, wherein said pick further comprises a curved peripheral lip adapted to engage the natural curvature of the user's finger or thumb surface.

12. The stringed instrument pick of claim 10, wherein said at least one raised grip pad comprises at least one edge adapted to be received by and interface with a user's fingerprint groove.

13. The stringed instrument pick of claim 10, wherein said at least one raised grip pad comprises at least one sharply angled edge, said at least one sharply angled edge adapted to be received by and interface with a user's fingerprint groove.

14. A stringed instrument pick, comprising:
a configuration defined by a first face, a second face, and a curved peripheral lip, wherein at least one of said first face and said second face comprises at least one raised grip pad formed over at least a portion thereof, said at least one raised grip pad adapted to be received by and interface with a user's fingerprint groove.

15. The stringed instrument pick of claim 14, wherein said curved peripheral lip is adapted to engage the natural curvature of the user's finger or thumb surface.

16. The stringed instrument pick of claim 14, wherein said at least one raised grip pad comprises at least one edge adapted to be received by and interface with the user's fingerprint groove.

17. The stringed instrument pick of claim 14, wherein said at least one raised grip pad comprises at least one sharply angled edge, said at least one sharply angled edge adapted to be received by and interface with the user's fingerprint groove.

18. A stringed instrument pick, comprising:
a configuration defined by a first face, a second face, and a sloped peripheral lip, wherein at least one of said first face and said second face comprises a plurality of raised grip pads formed over at least a portion thereof, said plurality of raised grip pads adapted to be received by and interface with a user's fingerprint groove.

19. The stringed instrument pick of claim 18, wherein said sloped peripheral lip is adapted to engage the natural curvature of the user's finger or thumb surface.

20. The stringed instrument pick of claim 18, wherein each raised grip pad of said plurality of raised grip pads comprises at least one edge adapted to be received by and interface with the user's fingerprint groove.

21. The stringed instrument pick of claim 18, wherein each raised grip pad of said plurality of raised grip pads comprises at least one sharply angled edge, said at least one sharply angled edge adapted to be received by and interface with the user's fingerprint groove.
